(19) United States
(12) Patent Application Publication
(10) Pub. No.: US 2007/0005352 A1
(43) Pub. Date: Jan. 4, 2007

(54) Receiver, transmitter and variable bandwidth transmission method

(75) Inventors: Petri J. Vaisanen, Kempele (FI); Olli Piirainen, Oulu (FI); Markku J. Vainikka, Kiviniemi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/441,117

(22) Filed: May 26, 2006

(30) Foreign Application Priority Data
Jun. 3, 2005 (FI) 20055284

(51) Int. Cl. G10L 19/02

(52) U.S. Cl. 704/229

(57) ABSTRACT

Solutions for receiving and transmitting variable transmission bandwidth signal are provided. A receiver comprises square-root raised cosine filter bank, each filter of the filter bank configured to filter a subband, and an adder configured to add up the output signals of one or more filters of the filter bank to obtain a sum signal, the sum of the subbands of the one or more filters being equal to the transmission bandwidth of the received signal. A transmitter comprises a transmission filter, the roll-off factor of the transmission filter being selected on the basis of the bandwidth of the signal to be transmitted.

### FIELD

The invention relates to transmission methods in telecommunication systems. In particular, the invention relates to systems where transmission bandwidth varies between users or where users employ variable bandwidth transmission.

### BACKGROUND

In telecommunication systems, the frequency spectrum is a limited resource. Therefore, transmission bandwidths used in communication are usually limited. This applies both analog and digital communication systems. Transmissions are also limited in the time domain.

Especially in digital communication systems, transmitted signals comprise time slots or frames, in which the signals are transmitted as pulses in finite lengths. However, because of the well-known Nyquist Criterion, square pulse shapes cannot be transmitted over a band-limited channel, because square pulse shapes occupy an infinite bandwidth and inter-symbol interference will happen. Therefore, signals are filtered prior to the transmission to shape the spectrum of the signal.

A signal with a raised cosine (RC) spectrum is widely used in telecommunications systems for transmissions between a transmitter and receiver. This applies to wireless communication systems in particular. In practice, the creation of the RC frequency response is usually split between a transmitter and a receiver. Thus, both the transmitter and the receiver comprise a transmission filter and the combined response of the filters is of the RC shape.

In systems where the transmission bandwidth of all users is the same, filters with fixed bandwidth may be used. In current and future wireless communication systems where services of different data rates are offered to the users, it is possible to have variable bandwidth transmissions. In such transmissions, the symbol period varies between different users and in some embodiments between different frames or time slots of the same user. This leads to a need to have variable bandwidth filters in transmitters and receivers.

In multiple access systems, variable bandwidth transmission means that each transmitter of the system may utilize a variable frequency band of the total bandwidth allocated to the system. In a fully loaded system, a receiver must be able to receive at all times the entire bandwidth allocated to the system. This applies to base stations in cellular telecommunication systems in particular. The proportion of the total bandwidth allocated to each transmitter at each time instant is variable, however.

From the implementation point of view, the variable bandwidth transmission is a problem in transmitter and especially in receiver filters. A prior art solution for adapting the filter response to the variable bandwidth transmission is to change the receiver filter's impulse response. In cellular base stations, receivers operate continuously. In practice, radio frequency (RF) parts and base band (BB) parts are typically separated. They are connected with each other through an RF-BB bus. The receiver filtering is performed in radio frequency part. Changing the filter impulse response by changing the filter in real time receiver filter operation is difficult and could result undesired transition responses causing undesirable interference to adjacent channels or to adjacent timeslots. This may be the case even if the transmission bandwidth is known by the receiver.

The receiver may have also another problem if the transmission bandwidth is not known beforehand. In this case, the used transmission bandwidth employed must be detected or estimated after the reception of a frame. The detection is performed by digital signal processing in the base band part. This would then require that the receiver be able to perform the receiver filtering after the actual transmission and detection of the transmission bandwidth.

### BRIEF DESCRIPTION OF THE INVENTION

An object of the invention is to provide an improved solution for variable bandwidth transmission. According to an aspect of the invention, there is provided a method for receiving a variable transmission bandwidth signal, the method comprising: filtering the received signal with one or more filters of a square-root raised cosine filter bank, each filter having the same input signal, and configured to filter a subband, and adding up the output signals of the one or more filters of the filter bank to obtain a sum signal, the sum of the subbands of the one or more filters being equal to the transmission bandwidth of the received signal and the center frequencies of filters filtering adjacent subbands being orthogonal to each other.

According to another aspect of the invention, there is provided a method for controlling transmission of a variable transmission bandwidth signal in a transmitter, the method comprising: selecting the roll-off factor of the transmission filter of the transmitter on the basis of the bandwidth of the signal to be transmitted.

According to yet another aspect of the invention, there is provided a receiver in a telecommunication system, comprising: a square-root raised cosine filter bank, each filter of the filter bank having the same input signal, and configured to filter a subband, and an adder configured to add up the output signals of one or more filters of the filter bank to obtain a sum signal, the sum of the subbands of the one or more filters being equal to the transmission bandwidth of the received signal and the center frequencies of filters filtering adjacent subbands being orthogonal to each other.

According to yet another aspect of the invention, there is provided a transmitter in a telecommunication system, comprising a transmission filter, wherein the transmitter is configured to select the roll-off factor of the transmission filter on the basis of the bandwidth of the signal to be transmitted.

Embodiments of the invention may be utilized in a base station and a mobile station of a telecommunication system.

The invention provides several advantages. The proposed structure will simplify the interface between radio frequency parts and base band parts (RF-BB) since the transmitter or receiver filter impulse responses do not have to change within real time operation. Thus, unwanted transition responses can be avoided. The transmission bandwidth can be determined in the base band processing after the reception of a frame or a time slot. The proposed structure enables blind transmission bandwidth detection in receiver base band processing. When the transmission bandwidth is detected, the sub-band signals can be combined.

In addition, a variable transmission bandwidth base station receiver can be implemented with simple fixed transmission bandwidth subband filters. The proposed square-root raised cosine filter bank can be implemented with computationally efficient polyphase structures with approximately the same complexity as one RRC receiver filter.

In the transmitter, the embodiments of the invention enable efficient variable bandwidth transmission and performing other receiver functions on the narrower bandwidth sub-band signals.

### LIST OF DRAWINGS

In the following, the invention will be described in greater detail with reference to the embodiments and the accompanying drawings, in which

FIG. 1 shows an example of a telecommunication system;

FIG. 2 illustrates an example of a receiver;

FIG. 3 illustrates a root raised cosine impulse response;

FIGS. 4A to 4C illustrate an example where a received signal is processed by two filters of a square-root raised cosine filter bank;

FIG. 5 illustrates a transmitter of an embodiment of the invention;

FIG. 6 illustrates the frequency response of a root raised cosine filter;

FIG. 7 illustrates a transmission filter structure of an embodiment of the invention;

FIG. 8 illustrates variable bandwidth multiple access transmission;

FIG. 9 illustrates an example of a filter structure and

FIG. 10 illustrates an embodiment of the invention in a flowchart.

### DESCRIPTION OF EMBODIMENTS

The present invention is applicable to various telecommunication systems. Typical examples of a system to which the invention can be applied are evolutions of the third generation cellular telecommunication systems, UMTS (Universal Mobile Telecommunications System). However, the invention is not limited to UMTS or any other cellular telecommunications system, as one skilled in the art is aware.

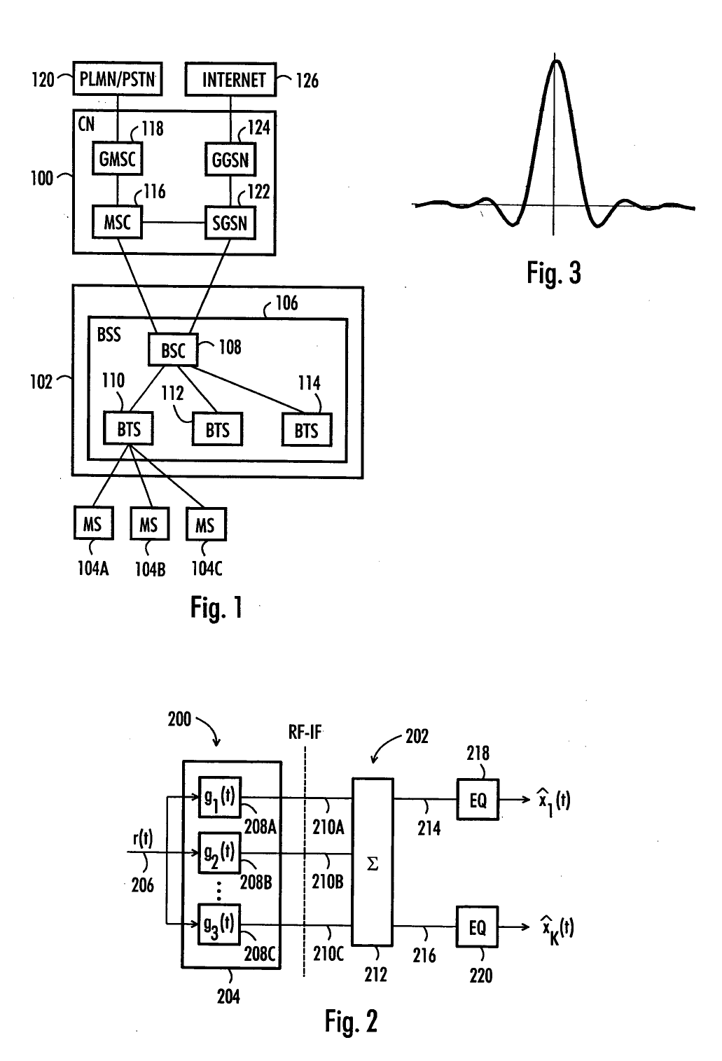

With reference to FIG. 1, examine an example of a data transmission system to which embodiments of the invention can be applied. FIG. 1 is a simplified block diagram describing the most important cellular telecommunication system parts at network element level. The structure and operation of the network elements are not described in detail, since they are commonly known.

The cellular telecommunication system may be divided into a core network (CN) 100, a radio access network (RAN) 102 and mobile stations (MS) 104A, 104B, 104C.

The RAN 102 includes a base station system (BSS) 106, which includes a base station controller (BSC) 108 and base stations (BTS) 110, 112 and 114.

The structure of the core network 100 supports both circuit-switched connections and packet-switched connections.

A Mobile Services Switching Center MSC 116 is the center of the circuit-switched side of the core network 100. The functions of the mobile services switching center 116 include: switching, paging, location registration of user equipment, handover management, collecting subscriber billing information, encryption parameter management, frequency allocation management and echo cancellation. The number of mobile services switching centers 116 may vary: a small network operator may be provided with a single mobile services switching center 116, but larger core networks 100 may be provided with several.

Larger core networks 100 may comprise a separate Gateway Mobile Services Switching Center GMSC 118 handling the circuit-switched connections between the core network 100 and external networks 120. The gateway mobile services switching centre 118 is located between the mobile services switching centres 116 and the external networks 120. The external network 120 may be for instance a Public Land Mobile Network PLMN or a Public Switched Telephone Network PSTN.

The network elements described in FIG. 1 are operational entities, and the physical implementation thereof may vary.

A Serving GPRS Support Node SGSN 122 is the center of the packet-switched side of the core network 100. The main task of the serving GPRS support node 122 is to transmit and receive packets with the user equipment 104A-104C supporting packet-switched transmission using the base station system 106. The serving GPRS support node 122 includes subscriber data and location information concerning the user equipment 104A-104C.

A Gateway GPRS Support Node GGSN 124 is the corresponding part on the packet-switched side to the gateway GMSC 118 on the circuit-switched side. The gateway GPRS support node 124 must be able to route the outgoing traffic from the core network 100 to external networks 126. In this example, the Internet represents the external networks 126.

The base station system 106 is composed of a Base Station Controller BSC 108 and Base Transceiver Stations or Base Stations BTS 110, 112 and 114. The base station controller 108 controls the base stations 110, 112 and 114. In principle, the aim is to place the equipment implementing the radio path and the functions associated therewith in the base station 110, 112 and 114 and to place the control equipment in the base station controller 108.

In this example, the base station 110, 112 and 114 includes at least one transceiver implementing a carrier, or eight time slots, or eight physical channels. Typically, one base station serves one cell, but such a solution is also possible, in which one base station 110, 112 or 114 serves several sectorized cells. The base station 110, 112 and 114 has following functions: calculations of timing advance, measurements in the uplink direction, channel coding, encryption, decryption and frequency hopping, for example.

The mobile station or subscriber terminal 104A-104C includes at least one transceiver that implements the radio connection to the radio access network 102 or to the base station system 106. In addition, the mobile station 104A-104C typically comprises an antenna, a processor controlling the operation of the device and a battery. Many kinds of mobile stations 104A-104C with various properties currently exist, for instance vehicle-mounted and portable terminals.

As stated earlier, a band-limited signal is usually filtered so that inter symbol interference (ISI) may be avoided. A signal with a raised cosine (RC) spectrum H_{rc} (f) is widely used in telecommunications systems because it has good properties against ISI. The equation for H_{rc} (f) may be of the following format:

$${H}_{rc} ( f ) = \{ \begin{matrix}T & 0 \leq \vert f \vert \leq \frac{1 - β}{2 T} \\ \frac{T}{2} \{ 1 + cos [ \frac{π T}{β} ( \vert f \vert - \frac{1 - β}{2 T} ) ] \} & \frac{1 - β}{2 T} \leq \vert f \vert \leq \frac{1 - β}{2 T} . \\ 0 & \vert f \vert > \frac{1 + β}{2 T}\end{matrix} \qquad ( 1 )$$

Above, β is the roll-off factor that determines the excess bandwidth over the Nyquist frequency, T is the symbol period and ½T is the Nyquist and at the same time the 3 dB frequency. The channel bandwidth is assumed to be W=1/T in this case.

The above equation presents an RC spectrum which is band-limited:

$${H}_{rc} ( f ) = 0 , \vert f \vert > \frac{1 + β}{2 T} .$$

The filtering operation is usually divided between the transmitter and the receiver. In the case where the frequency response C(f) of the transmission channel is ideal, i.e. C(f) =1, |f|≦W, H_{rc} (f) may be expressed as

$${H}_{rc} ( f ) = {G}_{T} ( f ) {G}_{R} ( f ) , \\ with$$

$${G}_{T} ( f ) = \sqrt{\vert {H}_{rc} ( f ) \vert} {ⅇ}^{- {j2π ft}_{0}}$$

where G_{R}(f)=G*_{T}(f) are the receiver and the transmitter filter responses, respectively. Here, * denotes complex conjugation, f denotes frequency and t₀ is a nominal delay. Thus, the overall RC spectral characteristic is split between the transmitter and receiver filters and if the channel is assumed ideal, the receiver filter is matched to the transmitter filter.

In an embodiment of the invention, variable transmission bandwidth receiver filtering is implemented with a square-root raised cosine filter bank (RRC-FB) having overall raised cosine power spectral characteristics. The RRC-FB splits the whole transmission bandwidth into smaller subbands and the total variable transmission bandwidth can be received by combining one or more subband responses. This combination of the power spectral responses of several RRC-FB sub-channels is characterized by an RC amplitude response.

FIG. 2 illustrates an example of a receiver equipped with a square-root raised cosine filter bank. The receiver of this example is a base station receiver configured to receive signals of several transmitters. The receiver comprises a radio frequency part 200 and a base band part 202. The radio frequency part comprises a square-root raised cosine filter bank 204. The input signal of the square-root raised cosine filter bank 204 is the received signal r(t) 206. The output signals 210a, 210b, 210c of the square-root raised cosine filter bank 204 are delivered to the base band part 202. The received signal r(t) 206 may comprise signals of several transmitters. The radio frequency part may comprise also other components, such as amplifiers, as one skilled in the art is aware.

The output signals 210a, 210b, 210c of the square-root raised cosine filter bank 204 are taken to an adder bank 212. In the adder bank, the output signals of the one or more filters of the filter band are added up to obtain one or more sum signals 214, 216. Each sum signal corresponds to a signal of one transmitter. Thus, one or more filters of the filter bank 204 are used to filter a signal of a transmitter and the output signals of these filters are added up in the adder bank 212. The sum of the subbands of the one or more filters used to filter a signal of a transmitter is equal to the transmission bandwidth of the received signal of the transmitter. The center frequencies of filters, i.e. sub-carriers of the exponentially modulated filter bank, used to filter a signal of a transmitter and filtering adjacent subbands, are orthogonal to each other.

The sum signals 214, 216 are each taken to prior art equalizers 218, 220, and at the output of the equalizers are estimates \hat{x}ᵢ(t) of the received signals, where i=1, . . . , K, and K is the number of transmitter signals. In the example of FIG. 2, K equals 2.

Thus, the square-root raised cosine filter bank 204 comprises a set of filters 208A-208C, each filter having a square-root raised cosine spectrum. Each filter has an impulse response gᵢ(t), which may be of the following format:
gᵢ(t)=e^{jω}^{ᵢ}^{t+θ}^{ᵢ}•h(t), I=1, . . . , N (2)
where N is the number of filters in the filter bank, j is the imaginary unit, ω is angular velocity of sub-carrier i, θ is phase and h(t) is a root raised cosine low-pass prototype impulse response, illustrated by FIG. 3. The phase θ is given by equation
θᵢ=θᵢ₊₁e^{±}^{^{π}}^{/}^{₂}^{j} (3)

The orthogonality of filters filtering adjacent subbands is determined by selecting the phase of the filters accordingly. For example, phases of filters filtering adjacent subbands may have a π/2 phase shift.

When a square-root raised cosine (RRC) low-pass prototype filter is (exponentially) modulated by the frequency of the inverse symbol rate, the overall power spectrum is the raised cosine (RC) response for the overall transmission bandwidth in consideration.

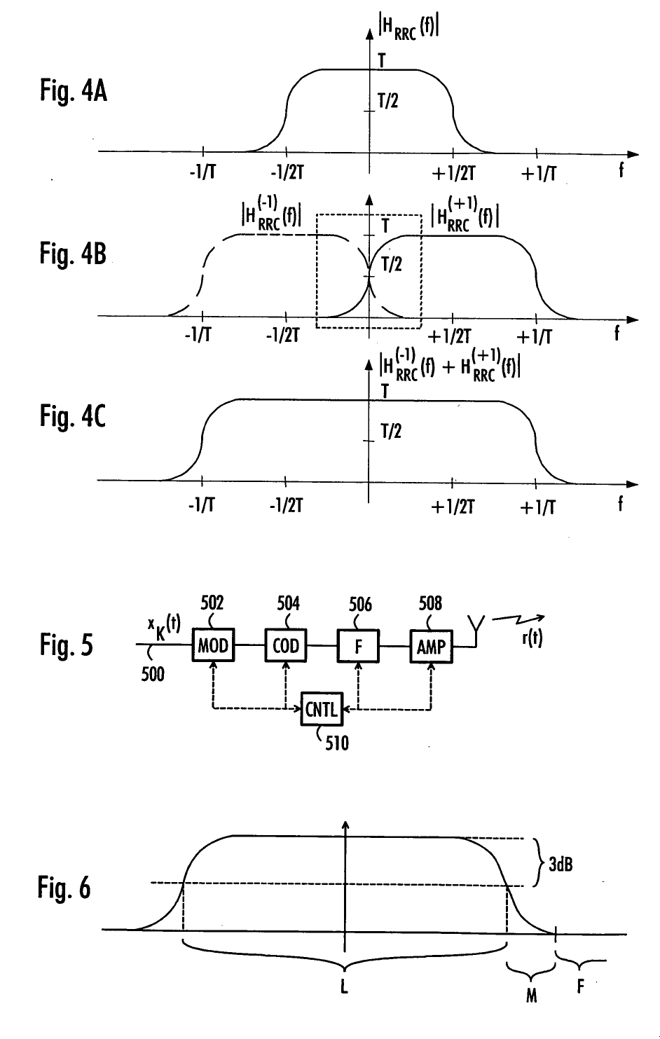

FIGS. 4A to 4C illustrate an example where a signal of a transmitter is processed by two filters of a square-root raised cosine filter bank. The overall transmission bandwidth 2W used by a transmitter is obtained by summing two RRC responses with a bandwidth W. Thus, there are two filters and two subbands with a bandwidth W. The two RRC responses are denoted by

$$\vert {H}_{RRC}^{( - 1 )} ( f ) \vert$$

$$and$$

$$\vert {H}_{RRC}^{( + 1 )} ( f ) \vert .$$

FIG. 4A shows the power spectrum of an RRC filter. FIG. 4B illustrates an embodiment where two RRC filters with adjacent subbands of bandwidth Ware used to filter the signal of a transmitter having a bandwidth of 2W. If the center frequencies of two RCC filters are orthogonal to each other, the square sum of the two responses becomes flat as FIG. 4C illustrates.

The RRC filter amplitude responses at the transition band near zero frequency may be defined in the following manner:

$${\vert {H}_{RRC}^{( - 1 )} ( f ) \vert}^{2} ≅ \frac{1}{2} ( 1 - cos 2 f ) = {sin}^{2} f$$

$${\vert {H}_{RRC}^{( + 1 )} ( f ) \vert}^{2} ≅ \frac{1}{2} ( 1 + cos 2 f ) = {cos}^{2} f$$

Thus, as sin² f+cos² f=1, combining the responses leads to a flat spectrum near the center frequency −β/2T≦f≦+β/2T.

FIG. 10 illustrates an embodiment of the invention in a flowchart. In step 1000, a signal is received. A first time slot or a first frame of a signal is received, for example. At this phase, the bandwidth of the received signal is not known.

In step 1010, the signal is filtered with a number of filters of the filter bank 204. The number of filters may be selected such that the total bandwidth of the filters is equal to the largest allowed bandwidth of a transmitted signal.

In step 1020, the receiver detects the bandwidth of the received signal.

In step 1030, the number of required filters of the filter bank 204 to cover the required bandwidth is determined. The required number of filters is adjusted on the basis of the determination. The already received and filtered time slot or frame is obtained by adding up the required outputs of filters.

In step 1040, the reception of the signal continues utilizing the required number of filters, and adding the filter outputs in the adder 212 and performing equalization in equalizer 218.

FIG. 5 illustrates a transmitter of an embodiment of the invention. Input to the transmitter is the signal xₖ(t) 500 to be transmitted. The signal is first modulated in a modulator 502 and channel coded in a coder 504. From the coder the signal is taken to a variable bandwidth transmission filter 506 having an impulse response h_{k,rc}(t). From the filter, the signal is taken to an amplifier 508 and transmitted to a transmission channel. In the channel, noise is added to the signal.

The transmitter may further comprise a controller 510. The controller 510 controls the operation of the transmitter. The controller 510 may control the bandwidth of the filter 502 according to need. The signal proceeds to the transmission channel 504, where noise is added 506 to the signal.

In an embodiment of the invention, the controller is configured to select the roll-off factor of the transmission filter 506 on the basis of the signal to be transmitted. The roll-off factor may be controlled on the basis of the bandwidth used in the transmission of the signal to be transmitted.

FIG. 6 illustrates a frequency response of a root raised cosine filter. In an ideal situation, the frequency response consists of unity gain at low frequencies L, the square root of the raised cosine function in the middle M, and total attenuation at high frequencies H. The low frequency area L is determined as the area within which the attenuation of the signal is smaller than 3 db. The width of the middle frequency areas at both ends of the response is defined by the roll off factor constant, which can be defined as the relation of the low frequency areas to the middle frequency area. The roll-off factor is always between 0 and 1.

When studying the operation of the receiver of FIG. 2, it may be noticed that as the total response of the receiving filter is obtained as a sum of fixed bandwidth filter output signals, the roll-off factor of the receiving filter depends upon the number of subbands used. Assuming W to be the bandwidth of a subband and β_{W} the roll-off factor of a subband, the roll-off factor of a filter obtained as a sum of two subbands and having a bandwidth of 2W is β_{2W}=0.5β_{W}. Respectively, the roll-off factor of a filter obtained as a sum of four subbands and having a bandwidth of 4W is β_{4W}=0.25β_{W}. To make the receiving filter and the transmission filter match, it is advantageous (but not necessary) to have equal roll-off factors in both filters.

In an embodiment of the invention, the controller is configured to select the transmission filter on the basis of the signal to be transmitted. By changing the number of sub-bands, the required bandwidth and roll-off factor may be obtained.

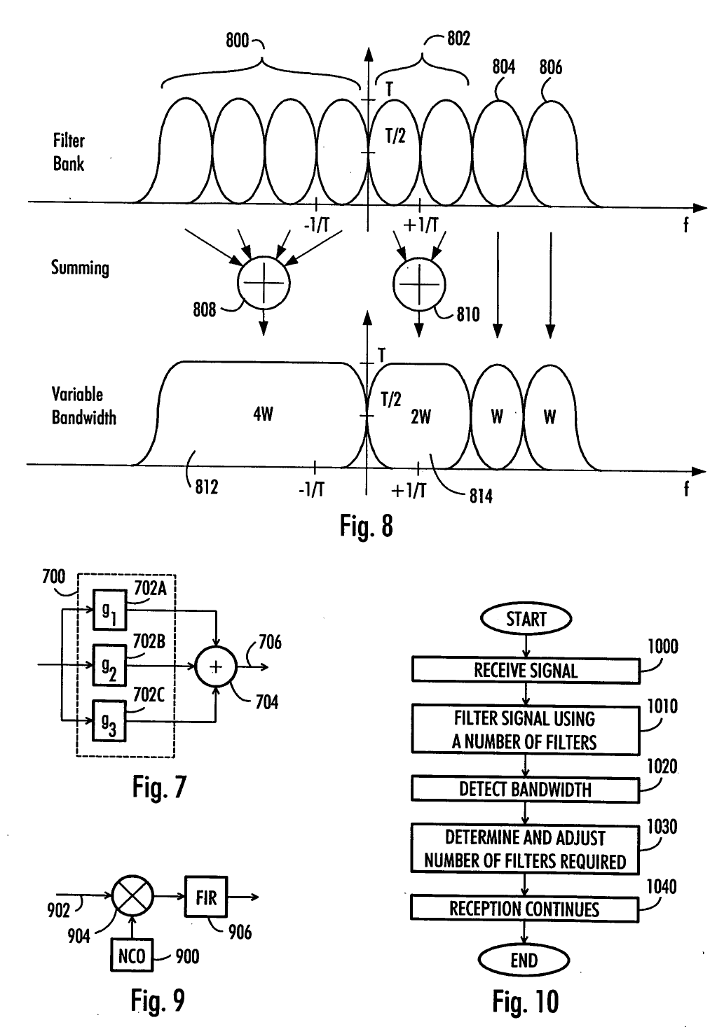

FIG. 7 illustrates an embodiment of the invention where the transmission filter is realized with a square-root raised cosine filter bank 700. The filter bank comprises a set of filters 702A to 702C, each filter having the same input signal, and configured to filter a subband. The bandwidth of each filter is fixed. The output signals of the filters are taken to an adder 704 which is configured to add up the output signals of one or more filters of the filter bank to obtain a sum signal 706. The bandwidth of the sum of the subbands of the one or more filters is equal to the transmission bandwidth of the signal to be transmitted and the center frequencies of filters filtering adjacent subbands are orthogonal to each other.

With the filter structure of FIG. 7 it is easy to obtain variable bandwidth transmission. When used in a base station of a telecommunication system, the structure enables easy realization of multiple access transmission. FIG. 8 illustrates the variable bandwidth multiple access transmission. FIG. 8 shows eight subbands 800-806 realized with eight filters of a filter bank 700. Assume that the bandwidth of each subband is W. Four leftmost subbands 800 are used for the transmission of a first user. Thus, the bandwidth of the signal of the first user is 4W. The outputs of the four leftmost filters are summed in an adder 808 and a signal 812 of bandwidth 4W is obtained.

The two subbands 802 are used in the transmission of a second user. Thus, the bandwidth of the signal of the second user is 2W The outputs of the filters are summed in an adder 810 and a signal 814 of bandwidth 2W is obtained.

Each of the subbands 804 and 806 is used in the transmission of a third and a fourth user. Thus, the bandwidth of the signals of the third and a fourth user is W. Summation is not needed as only one filter is used.

In an embodiment, the filters of the filter banks 212 and 700 are realized as a complex FIR (Finite Impulse Response) filter. FIG. 9 illustrates another embodiment, where the filters comprise a numerically controlled oscillator 900, whose output signal multiplies the signal 902 passing through the filter in the multiplier 904. The output signal of the numerically controlled oscillator 900 may be of format e^{jω}^{ᵢ}^{t+θ}^{ᵢ}. The output signal of the multiplier 904 is taken to a FIR filter 906 with impulse response h(t). The presented symbols correspond to equations 2 and 3 presented above. The filters may also be realized as a multirate filter system.

Embodiments of the invention may be implemented as a computer program. The computer program may be stored on a computer program distribution medium readable by a computer or a processor. The computer program medium may be, for example but not limited to, an electric, magnetic, optical, infrared or semiconductor system, device or transmission medium. may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method for receiving a variable transmission bandwidth signal, the method comprising:
filtering a received signal with one or more filters of a square-root raised cosine filter bank, each filter having a same input signal, and configured to filter a subband; and
adding up output signals of the one or more filters of the filter bank to obtain a sum signal, a sum of the subbands of the one or more filters being equal to the transmission bandwidth of the received signal and center frequencies of filters filtering adjacent subbands being orthogonal to each other.

2. The method of claim 1, further comprising: selecting a number of filters whose output is to be added up on the basis of the transmission bandwidth of the received signal.

3. The method of claim 1, further comprising: filtering the received signal with the one or more filters of a square-root raised cosine filter bank, each filter in the filter bank having a fixed bandwidth.

4. The method of claim 1, further comprising: measuring the bandwidth of the received signal periodically.

5. The method of claim 1, wherein the received signal comprises frames, and the bandwidth of the received signal is measured during each received frame.

6. A receiver in a telecommunication system, comprising:
a square-root raised cosine filter bank, wherein each filter of the filter bank has same input signal and is configured to filter a subband; and
an adder configured to add up output signals of one or more filters of the filter bank to obtain a sum signal, a sum of the subbands of the one or more filters being equal to a transmission bandwidth of a received signal and center frequencies of filters filtering adjacent subbands being orthogonal to each other.

7. The receiver of claim 6, wherein the obtained sum signal has a raised cosine filter spectrum.

8. The receiver of claim 6, wherein a bandwidth of each filter in the filter bank is fixed.

9. The receiver of claim 6, wherein the receiver is configured to select a number of filters whose output is to be added in the adder on the basis of the transmission bandwidth of the received signal.

10. A transmitter in a telecommunication system, comprising a transmission filter, wherein the transmitter is configured to select a roll-off factor of the transmission filter on the basis of a bandwidth of a signal to be transmitted.

11. The transmitter of claim 10, wherein the transmitter is configured to select the transmission filter on the basis of the signal to be transmitted.

12. The transmitter of claim 10, wherein the transmission filter is comprises:
a square-root raised cosine filter bank, wherein each filter of the filter bank has a same input signal and is configured to filter a subband; and
an adder configured to add up output signals of one or more filters of the filter bank to obtain a sum signal, a sum of the subbands of the one or more filters being equal to a transmission bandwidth of the signal to be transmitted and center frequencies of filters filtering adjacent subbands being orthogonal to each other.

13. The transmitter of claim 10, wherein the sum signal has a raised cosine filter spectrum.

14. The transmitter of claim 10, wherein a bandwidth of each filter in the filter bank is fixed.

15. A variable transmission bandwidth receiver in a telecommunication system, comprising:
a square-root raised cosine filter bank, wherein each filter of the filter bank has a same input signal and is configured to filter a subband; and
an adder configured to add up output signals of one or more filters of the filter bank to obtain a variable transmission bandwidth sum signal having a raised cosine filter spectrum, a sum of subbands of the one or more filters being equal to a transmission bandwidth of a received signal and center frequencies of filters filtering adjacent subbands being orthogonal to each other.

16. A base station receiver in a telecommunication system, comprising:
a square-root raised cosine filter bank, wherein each filter of the filter bank has a same input signal and is configured to filter a subband; and
an adder configured to add up output signals of one or more filters of the filter bank to obtain a sum signal, a sum of subbands of the one or more filters being equal to a transmission bandwidth of a received signal and center frequencies of filters filtering adjacent subbands being orthogonal to each other.

17. A mobile station receiver in a telecommunication system, comprising:
a square-root raised cosine filter bank, wherein each filter of the filter bank has a same input signal and is configured to filter a subband; and
an adder configured to add up output signals of one or more filters of the filter bank to obtain a sum signal, a sum of subbands of the one or more filters being equal to a transmission bandwidth of a received signal and center frequencies of filters filtering adjacent subbands being orthogonal to each other.

18. A base station transmitter in a telecommunication system, comprising a transmission filter, wherein the transmitter is configured to select a roll-off factor of the transmission filter on the basis of a bandwidth of a signal to be transmitted.

19. A mobile station transmitter in a telecommunication system, comprising a transmission filter, wherein the transmitter is configured to select a roll-off factor of the transmission filter on the basis of a bandwidth of a signal to be transmitted.

20. A method for controlling transmission of a variable transmission bandwidth signal in a transmitter, the method comprising: selecting a roll-off factor of the transmission filter of the transmitter on the basis of a bandwidth of a signal to be transmitted.

21. The method of claim 20, further comprising: filtering the signal to be transmitted with one or more filters of a square-root raised cosine filter bank, each filter of the filter bank having a same input signal and is configured to filter a subband; and
adding up output signals of the one or more filters of the filter bank to obtain a sum signal, a sum of the subbands of the one or more filters being equal to a transmission bandwidth of a signal and center frequencies of filters filtering adjacent subbands being orthogonal to each other.

22. A computer program embodied within a computer readable medium, the computer program including instructions for executing a computer process for receiving a variable transmission bandwidth signal, the process comprising:
filtering a received signal with one or more filters of a square-root raised cosine filter bank, each filter having the same input signal and configured to filter a subband; and
adding up output signals of the one or more filters of the filter bank to obtain a sum signal, a sum of the subbands of the one or more filters being equal to a transmission bandwidth of the received signal and center frequencies of filters filtering adjacent subbands being orthogonal to each other.

23. A computer program embodied within a computer medium, computer program including instructions for executing a computer process for transmitting a variable bandwidth signal in a transmitter comprising a transmission filter, the process comprising:
controlling a roll-off factor of the transmission filter on the basis of a bandwidth of a signal to be transmitted.

24. The computer program distribution medium of claim 22, the distribution medium including at least one of a computer readable medium, a program storage medium, a record medium, a computer readable memory, a computer readable software distribution package, a computer readable signal, a computer readable telecommunications signal, and a computer readable compressed software package.
